(19) United States
(12) Patent Application Publication
(10) Pub. No.: US 2009/0001018 A1
(43) Pub. Date: Jan. 1, 2009

(54) Operating Strategies in Filtration Processes

(76) Inventors: Fufang Zha, New South Wales (AU); Roger William Phelps, New South Wales (AU); Ashley Sneddon, New South Wales (AU); Tina Nguyen, New South Wales (AU)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/160,271

(22) PCT Filed: Jan. 12, 2007
(86) PCT No.: PCT/AU2007/000024

§ 371 Date: Jul. 8, 2008

(30) Foreign Application Priority Data
Jan. 12, 2006 (AU) 2006900146

(51) Int. Cl. B01D 61/12; B01D 61/22; B01D 61/32; B01D 61/54

(52) U.S. Cl. 210/636

(57) ABSTRACT

A method of operating a membrane filtration system having a number of repeated operation cycles, the method including the step of varying the values of one or more operating parameters of the system associated with a particular operation cycle between and/or during one or more repetitions of the operation cycle. Membrane filtration systems operating in accordance with the method are also disclosed.

### TECHNICAL FIELD

The present invention relates to cleaning of membranes in membrane filtration systems and, more particularly, to operating strategies in such systems to reduce energy requirements.

### BACKGROUND OF THE INVENTION

Reduction of operating energy and membrane fouling is a continued effort for the membrane system suppliers. In general, membrane fouling tends to be faster at a reduced energy input to clean the membrane. Different methods have been proposed to reduce the energy requirement without significant impact on the membrane fouling. U.S. Pat. Nos. 6,555,005 and 6,524,481 proposed an intermittent air scouring of the membranes instead of continuous air injection. In U.S. Pat. Nos. 6,245,239 and 6,550,747, a specific cyclic aeration system was proposed to reduce the air consumption in cleaning membranes. The cyclic aerating system described in the prior art requires fast responding valves to open and close at a high frequency and therefore wearing of valves is significant.

### DISCLOSURE OF THE INVENTION

According to one aspect, the present invention provides a method of operating a membrane filtration system having a number of repeated operation cycles, the method including the step of varying the values of one or more operating parameters of the system associated with a particular operation cycle between and/or during one or more repetitions of said operation cycle.

The method may also include adjusting filtration cycle time and/or other parameters according to the load to membranes.

Preferably, the method includes the step of varying the duration of the operation cycle. For preference, the method may include varying the values of one or more operating parameters instead of using constant values for such parameters. Such parameters may include but are not limited to, operating flux, transmembrane pressure and membrane scour air flow-rate.

For preference, the variation includes alternating the value of the operating parameter and/or the duration of the operating cycle between two or more predetermined values or durations. In one preferred form, the membrane filtration system includes at least two membranes or groups of membranes having distinct operating cycles, wherein the variation is alternated between said membranes or groups of membranes. For preference, said cycle duration may be varied in dependence on an operating parameter value, for example, transmembrane pressure (TMP) or operating flux. Alternatively, said cycle duration may be varied according to the change of a performance related parameter, for example, an increase in TMP or a change of permeability/resistance.

According to another aspect, the present invention provides a method of operating a membrane filtration system having a number of repeated operation cycles, the method including the step of varying the duration of a particular operation cycle between one or more repetitions of said operation cycle.

According to further aspects, the present invention also includes apparatus or membrane filtration systems adapted to operate according to the inventive methods.

### BRIEF DESCRIPTION OF THE DRAWINGS

Preferred embodiments of the invention will now be described, by way of example only, with reference to the accompanying drawings in which:

FIG. 1 is a graph illustrating alternating air scour flow-rate;

FIG. 2 is a graph illustrating the effect of alternating gas scour flow-rate on membrane permeability;

FIG. 3 is a graph illustrating a comparison of the effect of constant and alternating gas scour flow-rate on membrane permeability; and

FIG. 4 is a graph illustrating a comparison of membrane filtration performance (TMP) under different operating conditions.

### DESCRIPTION OF PREFERRED EMBODIMENTS

### Alternating Operating Parameters in Filtration Cycles

A filtration cycle in a membrane filtration system typically includes filtration stage and a backwash and/or relaxation stage. The method of one embodiment of the invention alternates the value of operating parameters between the filtration cycles. For systems which use gas scouring or aeration to clean the membranes, the operating parameters may include scour gas flow-rate, filtration flow-rate, or the like. For the scour gas, a normal gas flow-rate is used in one cycle and a lower or higher gas flow-rate for the next cycle in repeated cycles. Such an operating strategy does not require any special valves, has little impact on the membrane fouling and does not affect the membrane's net production of filtrate.

A typical filtration cycle in a membrane filtration system is in the range of 2 to 60 minutes for both drinking water and wastewater treatment, and more typically in the range of 3 to 45 minutes. The scour gas flow-rate alternates between the two gas flow-rates. The lower gas flow-rate used is related to the membrane properties and the scour duration. For a typical filtration cycle the lower gas flow-rate may be any rate below 100% of the normal value, but is preferred to be at least 20% of the normal rate in order to achieve alternation between filtration cycles and without significant impact on membrane fouling.

Such an alternating strategy can also be applied to other operating parameters of the system, for example, the filtration flow-rate. The filtration flux may be operated at two different rates: one cycle at normal flux and the other cycle at a higher flux in repeated cycles.

In the practical applications of this embodiment, such an alternating of operating parameters between two cycles can be applied to two membrane modules, two membrane racks or two membrane cells. For example, one membrane cell can be operated at the normal scour gas flow-rate and the other one at a lower scour gas flow in repeated cycles. The net gas requirement for the gas scouring is therefore reduced.

### Alternating Scour Gas Flow-Rate

According to another embodiment of the invention, the operating strategy flexibly varies the gas scour alternating frequency independent of the filtration cycle. It is simply to choose the normal gas flow duration and lower gas flow duration. It is preferred that the duration of lower gas flow is 0.5-5 times that for the normal gas flow.

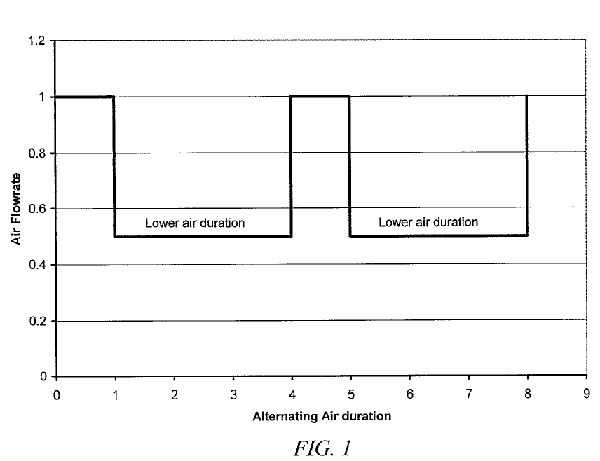

FIG. 1 illustrates the airflow pattern according to the strategy of this embodiment. The lower gas flow rate can be any rate less than 100% of the normal value, but is preferred to be at least 10% of the normal value to avoid significant membrane fouling.

In a network of membrane modules, this alternating strategy can be interchanged among corresponding sets of modules so that one set of modules receives the normal gas flow and the other sets of modules get the lower gas flow. For example, the duration of lower gas flow may be set to twice that of the normal gas flow. Then the gas alternation may be applied to three sets of modules—one set receives the normal gas flow and the other two lower gas flow.

### Adjusting Filtration Cycle Time According to Practical Load to Membrane

One undesirable side effect of the gas saving strategy used above is the increase in membrane fouling during operation at peak flux that occurs in wastewater treatment. The membranes are under stressed condition and the reduced energy input achieved by scouring at a lower gas flow can make the situation worse. To overcome this difficulty, the operating strategy is changed by reducing the duration of the filtration cycle.

This is based on the principle that backwash or relaxation is dependent on the membrane's resistance rise, not on the fixed filtration time. The resistance rise rate will double or more when the membrane operating flux doubles. If the filtration time is fixed to being the same as used with the normal flux, then the resistance rise will be significant at the higher flux operation, resulting in difficulty recovering the membrane performance through backwash or relaxation and leading to a continuous rise in the membrane resistance. However, if the filtration time is reduced, the membrane resistance rise is less and it is easier to recover the membrane performance.

The membrane resistance increase is a preferred indicator to determine the backwash or relaxation cycle requirements. Other parameters such as transmembrane pressure (TMP) increase and permeability decline may also be used as indicators to determine the necessity for a backwash/relaxation cycle. For example, if the filtration time is 12 minutes at normal flux, the filtration time can be reduced to 6 minutes or less at a flux twice the normal one.

### Example 1

This example demonstrates the effect of alternating gas flow on the membrane fouling. The example uses a membrane bioreactor system set up for municipal wastewater treatment. A membrane bioreactor module was installed in a membrane tank. Mixed liquor from an aerobic tank was fed to the membrane tank at a flow rate of five times that of the filtrate flow rate (5Q) and the extra mixed liquor was circulated back to the aerobic tank. The MLSS concentration in the membrane tank was in the range of 10-12 g/L. The membrane filtration was carried out in a filtration and relaxation mode and no liquid backwash was used during operation of the system. The following operating condition was applied:

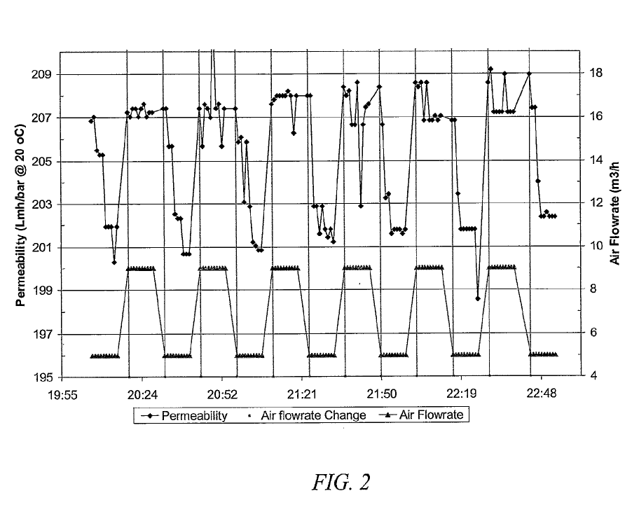

1. Standard operating condition: 12 minutes filtration and 1 minute relaxation with continuous gas (in this example, air) scouring at 9 m³/hr;
2. Alternating air flow-rate at 9 and 5 m³/hr in filtration cycles, that is, 13 minutes at 9 m³/hr air and 13 minutes at 5 m³/hr air. FIG. 2 shows such an alternating pattern and the change of the membrane permeability with the air flow-rate.

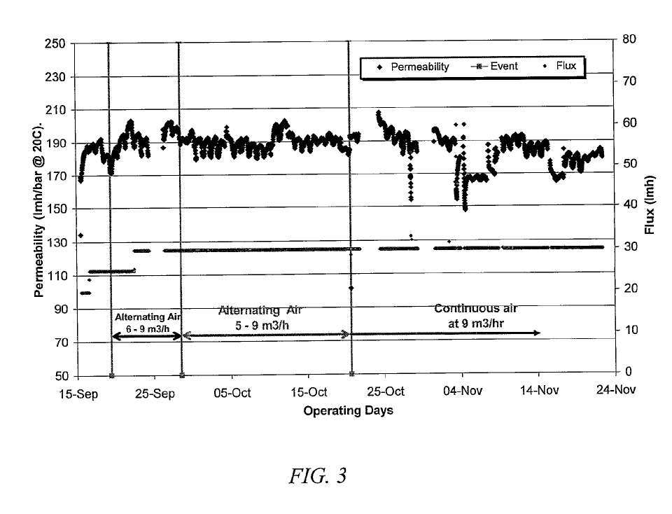

FIG. 2 shows that at a lower scour gas flow-rate, the membrane fouled quickly and the permeability of membrane dropped sharply. However, the permeability was largely recovered when the gas flow-rate was raised. An extended test was conducted and compared with the constant airflow in FIG. 3. At the normal operating flux of 30 L/m²/hr, the membrane fouling rate was little changed under the alternating gas flow operation between 9 and 5 m³/hr.

This example demonstrates that the membrane scour gas can be supplied at alternating flow rates without impacting on the membrane fouling. In this example, the net gas supply required to effectively scour the membrane was reduced by 22%.

### Example 2

This example demonstrates how to change the operating strategy to cope with the peak flux operation. The membrane filtration system set-up was the same as in Example 1.

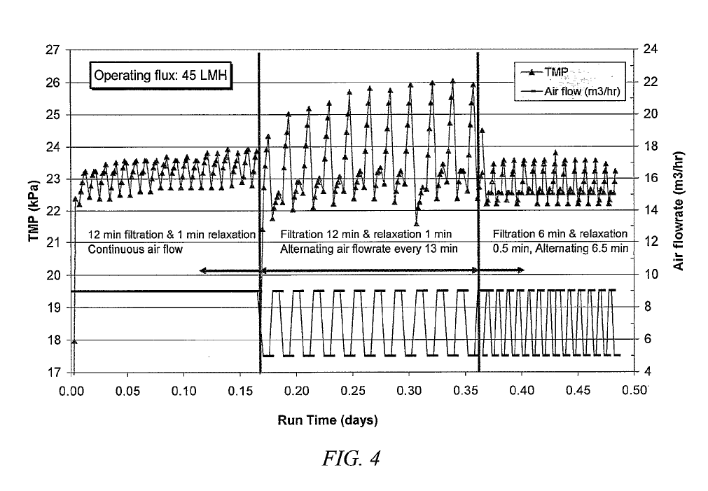

In this Example, the operating flux was increased by 50% from 30 to 45 L/m²/hr. Under such a high load condition, the operating transmembrane pressure (TMP) increases much faster during the filtration period. The situation becomes more stressed at the lower air flow-rate. FIG. 4 shows the testing result under different operating strategies. The transmembrane pressure (TMP) was increased by about 1 kPa during 12 minutes filtration cycle with a supply of scour air at a flow rate of 9 m³/hr, but increased by more than 3 kPa when the air flow rate was reduced to 5 m³/hr. The faster transmembrane pressure (TMP) rise indicates a rapid fouling of the membrane. The membrane fouling tends to be more difficult to recover by relaxation, leading to a gradual consistent increase in TMP. If the filtration time is shortened to 6 minutes and relaxation is also reduced to 30 seconds then the TMP rises only about 1 kPa at the low airflow rate, making it easier to recover by relaxation. FIG. 4 shows that an alternating air strategy could also be effectively applied at peak flux by shortening the filtration cycle.

It will be appreciated that further embodiments and exemplifications of the invention are possible without departing from the spirit or scope of the invention described.

1. A method of operating a membrane filtration system, the method comprising the steps of:
providing a plurality of repeated operation cycles; and
varying a value of one or more operating parameters of said system associated with a particular operation cycle between one or more repetitions of said operation cycle.

2. (canceled)

3. A method according to claim 1 including adjusting parameters according to the load to membranes.

4. A method according to claim 1 further comprising the step of varying the duration of the operation cycle.

5. A method according to claim 1 including varying the values of one or more operating parameters instead of using constant values for such parameters.

6. A method according to claim 5 wherein said parameters include one or more of the following: operating flux, transmembrane pressure and membrane scour air flow-rate.

7. A method according to claim 1 wherein the variation includes alternating the value of the operating parameter and/or the duration of the operating cycle between two or more predetermined values or durations.

8. A method according to claim 1 wherein the membrane filtration system includes at least two membranes or groups of membranes having distinct operating cycles and wherein the variation is alternated between said membranes or groups of membranes.

9. A method according to claim 1 wherein said cycle duration is varied in dependence on an operating parameter value.

10. A method according to claim 9 wherein the operating parameter is transmembrane pressure (TMP).

11. A method according to claim 9 wherein the operating parameter is operating flux.

12. A method of operating a membrane filtration system, the method comprising the steps of:
providing a plurality of repeated operation cycles, and;
varying the duration of a particular operation cycle between one or more repetitions of said operation cycle.

13. (canceled)

14. A membrane filtration system comprising:
means for operating said system with a number of repeated operation cycles and;
control means for varying the values of one or more operating parameters of said system associated with a particular operation cycle between one or more repetitions of said operation cycle.

15. A membrane filtration system comprising:
means for operating said system with a number of repeated operation cycles and;
control means for varying the values of one or more operating parameters of said system associated with a particular operation cycle during one or more repetitions of said operation cycle.

16. A membrane filtration system comprising
means for operating said system with a number of repeated operation cycles and;
control means for varying the duration of a particular operation cycle between one or more repetitions of said operation cycle.

17. A method of operating a membrane filtration system, the method comprising the steps of:
providing a plurality of repeated operation cycles; and
varying the values of one or more operating parameters of said system associated with a particular operation cycle during one or more repetitions of said operation cycle.

18. A method according to claim 17 including adjusting parameters according to the load to membranes.

19. A method according to claim 17 further comprising the step of varying the duration of the operation cycle.

20. A method according to claim 17 including varying the values of one or more operating parameters instead of using constant values for such parameters.

21. A method according to claim 17 wherein the membrane filtration system includes at least two membranes or groups of membranes having distinct operating cycles and wherein the variation is alternated between said membranes or groups of membranes.
